(19) United States
(12) Patent Application Publication
(10) Pub. No.: US 2012/0314358 A1
(43) Pub. Date: Dec. 13, 2012

(54) KEYBOARD DEVICE CAPABLE OF SUPPORTING A TABLET PERSONAL COMPUTER

(76) Inventor: Shao-Chieh TING, Banchiau City (TW)

(21) Appl. No.: 13/154,785

(22) Filed: Jun. 7, 2011

(51) Int. Cl. G06F 1/16

(52) U.S. Cl. 361/679.09

(57) ABSTRACT

The present invention discloses a multifunctional computer keyboard device. A rear side at a top cover of the keyboard is provided with a U-shaped groove to emplace a tablet personal computer. A rear side at a bottom cover of the keyboard is provided with two U-shaped brackets. One bracket is turned open to support the tablet personal computer and increase stability thereof, preventing it from falling down due to imbalance. When the keyboard is not in use, the other bracket is turned open to rotate and put the keyboard upside down on a desktop, enabling solution to a trouble that the keyboard occupies a desktop space. The U-shaped brackets can be replaced by a prismatic-shaped audio device, which can increase a length of the keyboard to prevent the personal tablet computer from falling down due to imbalance and can also improve a sound effect of the tablet personal computer.

### BACKGROUND OF THE INVENTION

a) Field of the Invention

The present invention relates to a keyboard device capable of supporting a tablet personal computer, and more particularly to a multifunctional keyboard device which can be used to support a tablet personal computer and is able to be put upright on a desktop.

b) Description of the Prior Art

As progress of computer technologies, a computer input device has been evolved from keyboard input, mouse input and stylus input to finger input, in addition to voice input. In this era that computer touch-control is prevailing, although being not used frequently, the keyboard input is still indispensable. However, existing keyboards sold on markets are only provided with a single function of input.

Furthermore, an issue of containing keyboards that are not used often arises, such as how to put them when they are not used or how to easily access them when they are needed.

When an existing keyboard of a desktop computer is idle and not used, it is usually put horizontally on a desktop. Yet, this emplacement will occupy a very large space on the desktop and can increase a probability that the keyboard can be damaged. Accordingly, there are vendors who raise a rear side of the keyboard, so that the space of desktop can be saved by putting upright a widened rear wall of the keyboard when the keyboard is not used, as a keyboard height refers to a distance from a top center of a key in a home row (i.e., a center row of keys in five horizontal rows of keys of a normal keyboard), when the key is not pressed down, to the desktop. According to ISO 9241, that distance was recommended to be no greater than 35 mm and was preferably 30 mm; whereas, an inclination of the keyboard (i.e., an angle of inclination of the keyboard relative to the desktop) was 5° to 12°, but no greater than 15°. Therefore, if a width at a bottom of the keyboard is increased after the keyboard has been put upright in order to pursue upright stability of the keyboard, it not only will cause uncomfortableness to a user, but will invert root and branch. On the other hand, if the width at the rear side of the keyboard is not enough, the keyboard can be easily collapsed by an external force or shaking of the desk.

### SUMMARY OF THE INVENTION

The primary object of the present invention is to provide a keyboard device capable of supporting a tablet personal computer, wherein through increasing a base area of the keyboard after turning open a large U-shaped bracket on a bottom cover, the tablet personal computer can be put on the keyboard in balance, without falling down due to imbalance.

Another object of the present invention is to provide a keyboard device capable of supporting a tablet personal computer, wherein through a small U-shaped bracket, a bottom support surface of the keyboard is enlarged after putting upright the keyboard, which allows the keyboard to stably stand on a desktop without falling down by a mild external force or shaking of a table. In addition, a desktop space can be saved.

Still another object of the present invention is to provide a keyboard device capable of supporting a tablet personal computer, wherein the U-shaped brackets can be replaced by a prismatic-shaped audio device to equally achieve an effect of stabilizing the tablet personal computer. In a mean time, a sound effect of the tablet personal computer can be improved.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a front side of the present invention.

FIG. 2 shows a three-dimensional schematic view of a rear side of the present invention.

FIG. 3 shows a three-dimensional exploded view of the present invention.

FIG. 4 shows a schematic view of the present invention, with that a large U-shaped bracket is rotated open.

FIG. 5 shows a three-dimensional schematic view of the present invention, with that a tablet personal computer is put upright vertically.

FIG. 6 shows a three-dimensional schematic view of the present invention, with that a tablet personal computer is put upright horizontally.

FIG. 7 and FIG. 8 show schematic views of the present invention, with that a small U-shaped bracket is turned open.

FIG. 9 and FIG. 10 show three-dimensional schematic views of the present invention using a prismatic-shaped audio device.

FIG. 11 shows a three-dimensional exploded view of the present invention using a prismatic-shaped audio device.

FIG. 12 shows a schematic view of emplacement of the present invention using a prismatic-shaped audio device.

### DETAILED DESCRIPTION OF THE PREFERRED EMBODIMENTS

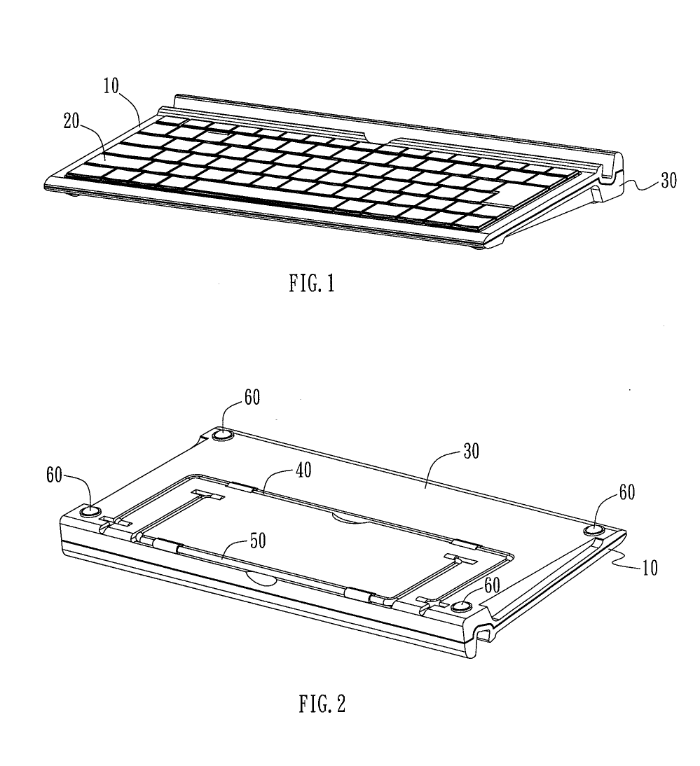

Referring to FIG. 1 and FIG. 2, it shows three-dimensional views of the present invention. As shown in the drawings, a keyboard of the present invention comprises a top cover 10, plural key buttons 20 provided on the top cover 10, a bottom cover 30, as well as a large U-shaped bracket 40, a small U-shaped bracket 50 and plural anti-slip pads 60 provided on the bottom cover 30.

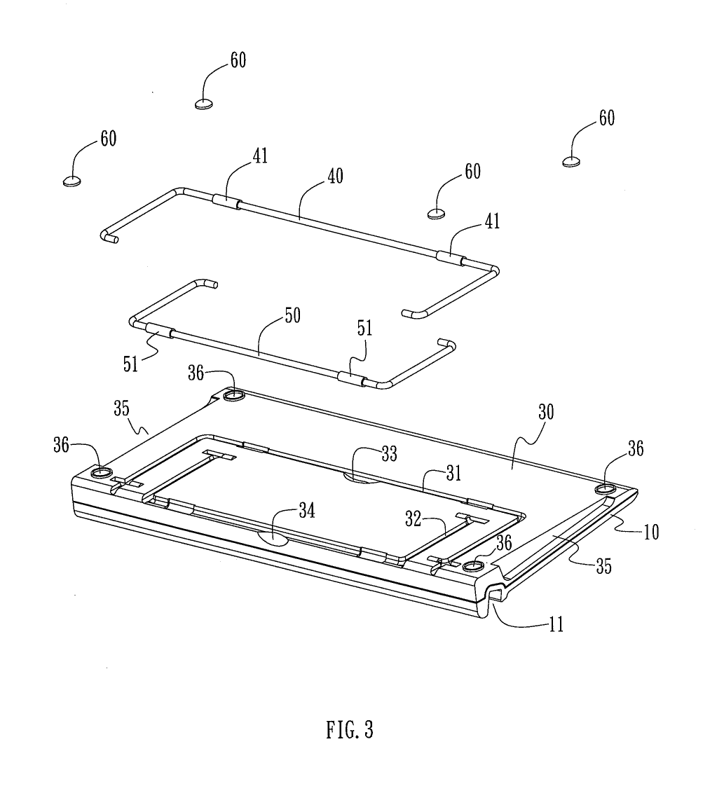

Referring to FIG. 3 at a same time, it shows a three-dimensional exploded view of the present invention. As shown in the drawing, a rear side of the top cover 10 is provided with a U-shaped groove 11 to put upright a tablet personal computer. The bottom cover 30 is provided with containing slots 31,32 to hold the large and small U-shaped brackets 40,50, and finger grooves 33,34 to facilitate turning open the brackets. Two sides of the bottom cover 30 are provided with respectively with a hand-held groove 35 to facilitate a user to hold with hands to move the keyboard. In addition, anti-slip pad containing slots 36 are used to emplace the anti-slip pads 60.

The large and small U-shaped brackets 40,50 are provided with plural anti-slip rings 41,51.

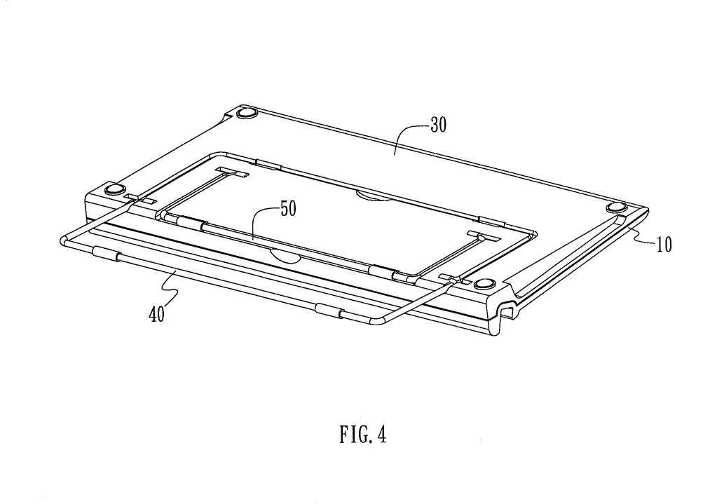

Referring to FIG. 4 at a same time, it shows a schematic view of the present invention, with that the large U-shaped bracket 40 is turned open from the large U-shaped bracket containing slot 31 on the bottom cover 30. After turning open the large U-shaped bracket 40, a base area of the keyboard is increased such that when the tablet personal computer is put in for use, it will not fall down due to imbalance. In addition, when the tablet personal computer is not in use, the large U-shaped bracket 40 is restored into the large U-shaped bracket containing slot 31.

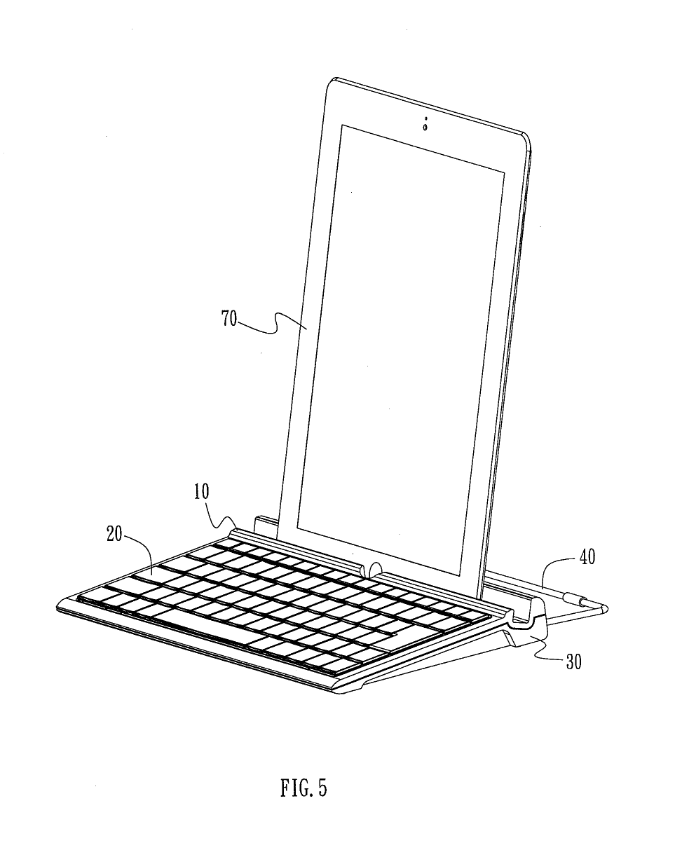

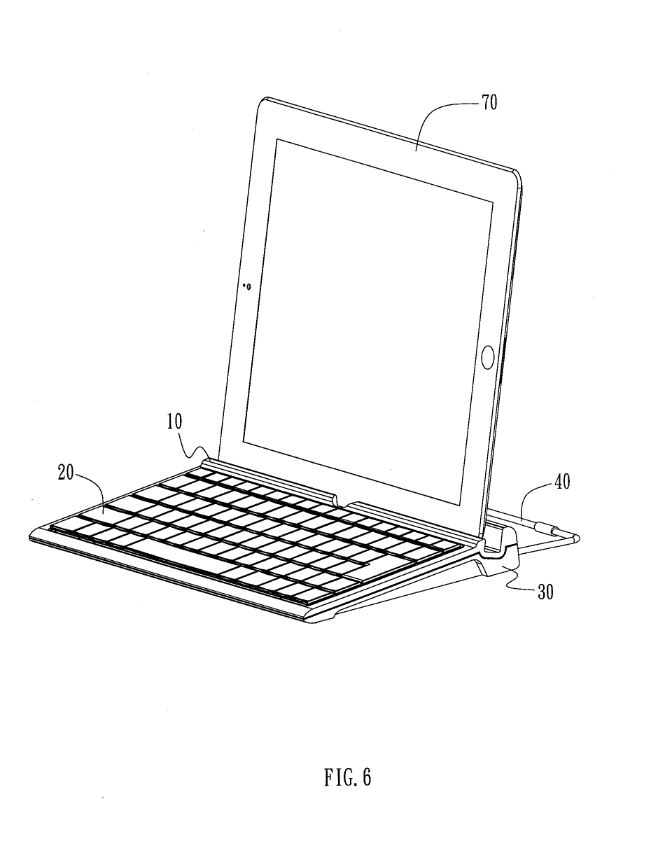

Referring to FIG. 5 and FIG. 6 at a same time, it shows three-dimensional schematic views of the present invention, with that a tablet personal computer 70 is put on the keyboard for use.

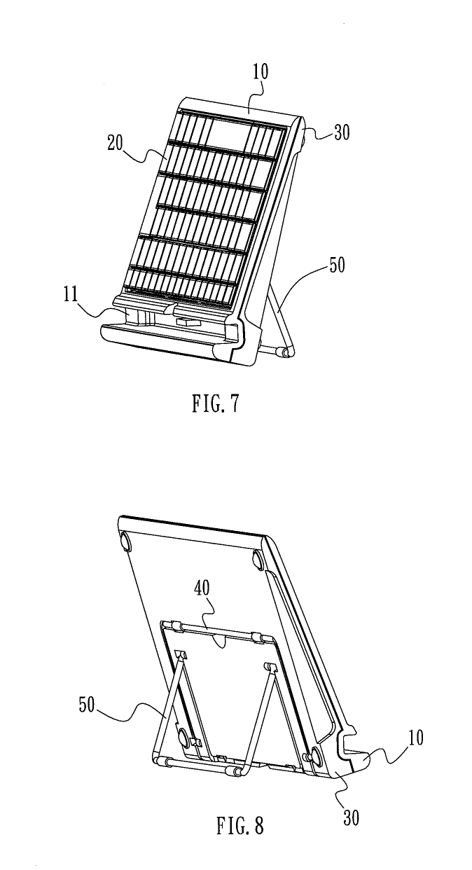

Referring to FIG. 7 and FIG. 8 at a same time, the small U-shaped bracket 50 is turned open from the small U-shaped bracket containing slot 32 on the bottom cover 30 to increase a contact area between the keyboard and a working platform when the keyboard is put upright, thereby increasing the stability of keyboard after being put upright. In addition, when the keyboard is not in use, the small U-shaped bracket 50 is restored into the small U-shaped bracket containing slot 32. Therefore, comparing with the prior art, the keyboard of the present invention is apparently improved in terms of structures.

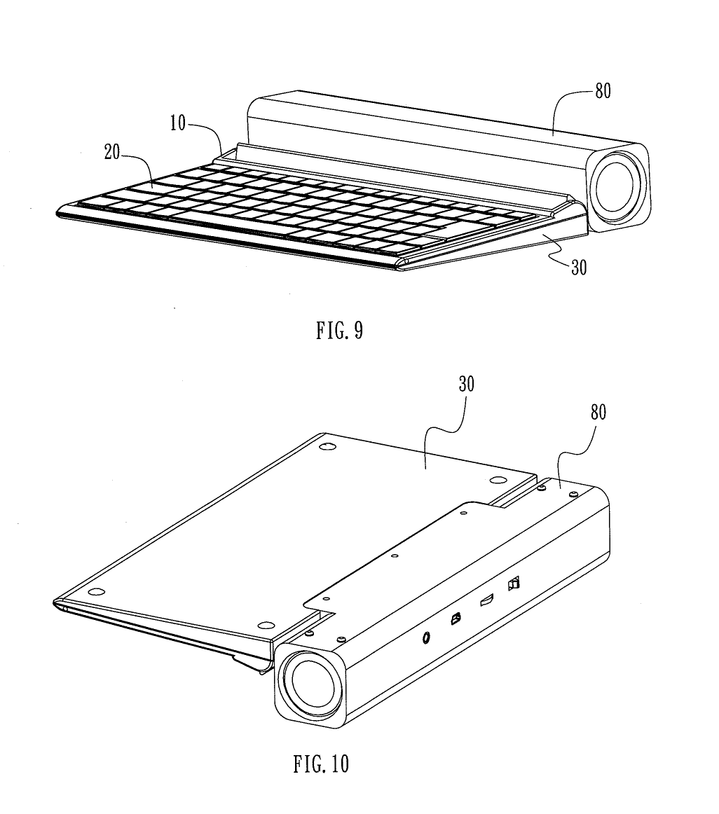

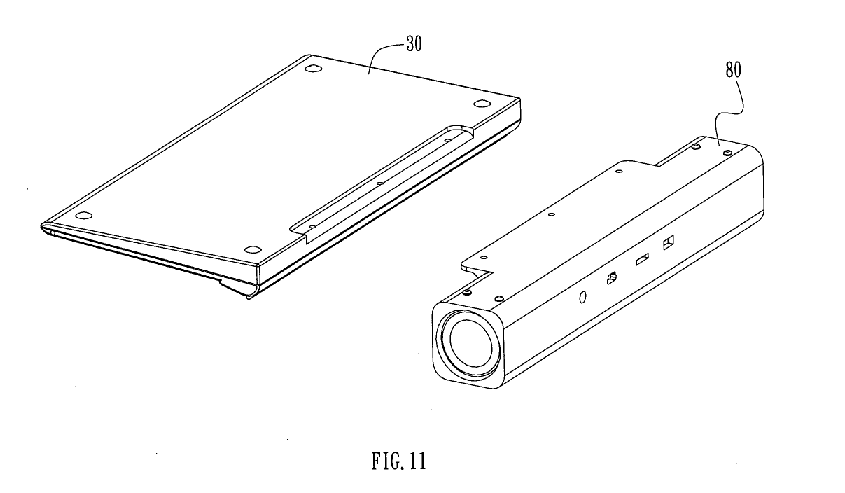

Referring to FIG. 9 and FIG. 10, it shows three-dimensional schematic views of the present invention, with that the U-shaped brackets are further replaced by a prismatic-shaped audio device 80. The prismatic-shaped audio device 80 can increase the stability in using the tablet personal computer and can also improve a sound effect of tablet personal computer.

Referring to FIG. 11, it shows a three-dimensional exploded view of the present invention using the prismatic-shaped audio device 80.

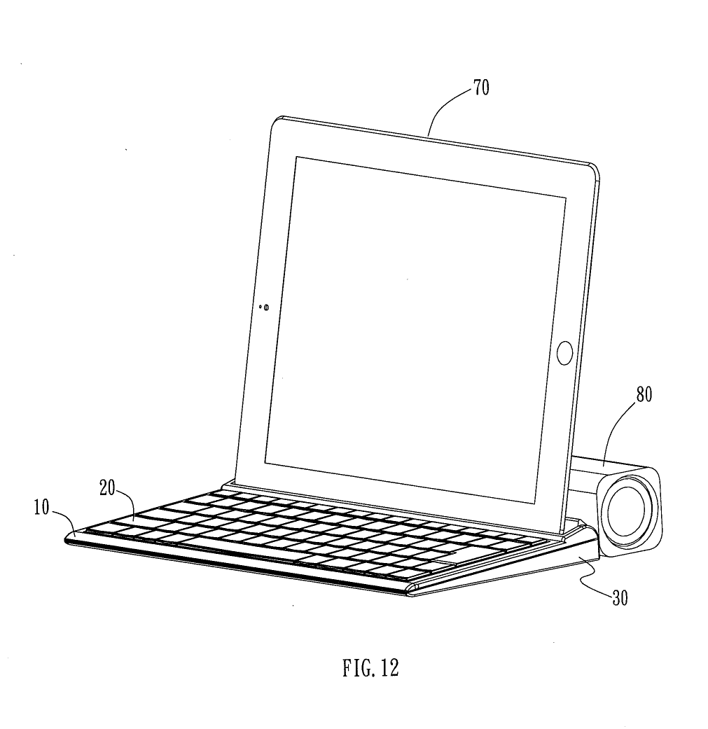

Referring to FIG. 12, it shows a schematic view of the present invention using the tablet personal computer 70 and the prismatic-shaped audio device 80.

Accordingly, the keyboard device capable of supporting the tablet personal computer of the present invention is not only provided with the function of supporting the tablet personal computer, but able to be put upright stably. In addition, the keyboard is also provided with a user-friendly operation method and an ergonometric design that it can provide for use in industries and has not been used in public yet.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A keyboard device capable of supporting a tablet personal computer comprising:
a top cover on which is provided with a groove to emplace a tablet personal computer;
a plurality of key buttons provided on the top cover;
a bottom cover on which is provided with containing slots to hold a large U-shaped bracket and a small U-shaped bracket;
the large U-shaped bracket which is turned open from a large U-shaped bracket containing slot on the bottom cover to increase a base area of the keyboard, allowing the tablet personal computer to be balanced while in use;
the small U-shaped bracket which is turned open from a small U-shaped bracket containing slot on the bottom cover to increase a contact area between the keyboard and a working platform when the keyboard is put upright, thereby increasing stability of the keyboard after being put upright; and
a plurality of anti-slip pads provided on the bottom cover.

2. The keyboard device capable of supporting a tablet personal computer, according to claim 1, wherein the keyboard provides for putting upright the tablet personal computer.

3. The keyboard device capable of supporting a tablet personal computer, according to claim 1, wherein the keyboard stands stably through provision of the small U-shaped bracket.

4. The keyboard device capable of supporting a tablet personal computer, according to claim 1, wherein the U-shaped brackets are further replaced by a prismatic-shaped audio device.
